(19) United States
(12) Patent Application Publication
(10) Pub. No.: US 2020/0246962 A1
(43) Pub. Date: Aug. 6, 2020

(54) Drill Accessory

(71) Applicant: Mohammad Bader, Mississauga (CA)

(72) Inventor: Mohammad Bader, Mississauga (CA)

(21) Appl. No.: 16/263,252

(22) Filed: Jan. 31, 2019

(51) Int. Cl. B25H 1/00

(52) U.S. Cl. CPC B25H 1/0092; B25B 23/18

(57) ABSTRACT

A drill accessory that is configured to be releasably secured to a handheld drill wherein the drill accessory is operable to project a straight line light beam in four directions outward therefrom and along an adjacent surface. The drill accessory includes a chuck engagement member that is configured to be inserted into a chuck of a handheld drill. A body is contiguous with the drill engagement member and is cylindrical in shape having a first end and a second end. A light assembly is included and has four lights distributed equidistantly along the outer perimeter of the light assembly. A bearing assembly is intermediate the body and the light assembly and includes a plurality of ball bearings. The bearing assembly is operable to inhibit the rotational movement of the body being transferred to the light assembly so as to maintain the light assembly in a stationary position.

### FIELD OF THE INVENTION

The present invention relates generally to drill accessories, more specifically but not by way of limitation, a drill accessory that is configured to releasably secure with a drill chuck wherein the drill accessory is configured to display an x-axis and y-axis line via a laser and is further operable to secure a drill bit therein.

### BACKGROUND

Drill attachments are known in the art. Power drills are regularly utilized in numerous types of construction activities. Formerly, drills were utilized for the purpose of drilling holes with various sizes of drill bits but over the last several decades numerous attachments have been developed that has greatly expanded the utilization of the hand held drill. Hand held drill utilization has especially expanded ensuing the development of improved battery technology wherein portable hand held drills now have a suitable power source that is not tethered to a power outlet via a power cord. Hand held drill accessories range from various sanding tools, pumps and many other types of accessories wherein the accessories are insertable into the drill chuck and the rotation thereof facilitates the operation of the accessory.

As hand held drills now have an effective independent power source, their utilization as a power screwdriver is more popular than ever. For applications that require the installation of a multitude of screws such as but not limited to roofing or drywall installation, the use of hand held drills is preferred. In the aforementioned applications and many others, a material is being superposed a support system and secured thereto utilizing screws. By way of example but not limitation, the installation of drywall involves the overlay of drywall onto wall or ceiling joists and the drywall is screwed to the joists utilizing a special drywall screw. The joists or studs are typically less than two inches in width and the drywall must be screwed to these joists or studs over lengths in excess of eight feet. One challenge for those installing drywall is maintaining the screw installation such that each screw properly engages the joist or stud in a straight line along the stud or joist. In order to accomplish the aforementioned, installation of fasteners must be performed in a straight line. This may also be desirable from a cosmetic perspective. As a user installs the drywall, maintaining proper orientation with the other screws and as such the joist or stud becomes a significant challenge. While marks may be present at ends of the drywall, it is nearly impossible for a user to maintain a straight line so as to ensure proper screw alignment and installation.

Accordingly, there is a need for a drill accessory that is configured to be operably secured into the chuck of a handheld drill wherein the drill accessory includes a housing that is stationary and a drill member that is rotational wherein the stationary housing includes lights operable to direct light beams along an x-axis and a y-axis relative to the center of the drill accessory.

### SUMMARY OF THE INVENTION

It is the object of the present invention to provide a drill accessory configured to assist a user in the maintenance of screwing a straight horizontal or vertical line wherein the drill accessory includes a chuck engagement member configured to be inserted into the chuck of a conventional handheld drill.

Another object of the present invention is to provide a drill accessory operable to provide a visual guidance so as to assist a user in drilling or screwing in a straight horizontal or vertical line wherein the chuck engagement member includes a body extending outward therefrom.

A further object of the present invention is to provide a drill accessory configured to assist a user in the maintenance of screwing a straight horizontal or vertical line that further includes a bearing assembly surroundably secured to the body of the chuck engagement member.

Still another object of the present invention is to provide a drill accessory operable to provide a visual guidance so as to assist a user in drilling or screwing in a straight horizontal or vertical line wherein the bearing assembly is configured to have secured therein a plurality of ball bearings.

An additional object of the present invention is to provide a drill accessory configured to assist a user in the maintenance of screwing a straight horizontal or vertical line that further includes a light assembly wherein the light assembly is operably secured to the bearing assembly.

Yet a further object of the present invention is to provide a drill accessory operable to provide a visual guidance so as to assist a user in drilling or screwing in a straight horizontal or vertical line wherein the light assembly is operable to stay stationary during rotation of the chuck engagement member.

Another object of the present invention is to provide a drill accessory configured to assist a user in the maintenance of screwing a straight horizontal or vertical line wherein the light assembly includes light projecting members on the circumference thereof.

Still another object of the present invention is to provide a drill accessory operable to provide a visual guidance so as to assist a user in drilling or screwing in a straight horizontal or vertical line wherein the chuck engagement member includes a chuck extension forwardly located of the light assembly.

An additional object of the present invention to provide a drill accessory configured to assist a user in the maintenance of screwing a straight horizontal or vertical line wherein the chuck extension is configured to receive an operation bit therein such as but not limited to a drill bit or screwdriver bit.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention coupled with a conventional handheld drill; and

FIG. 2 is a front view of the present invention; and

FIG. 3 is a side perspective view of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a drill accessory 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

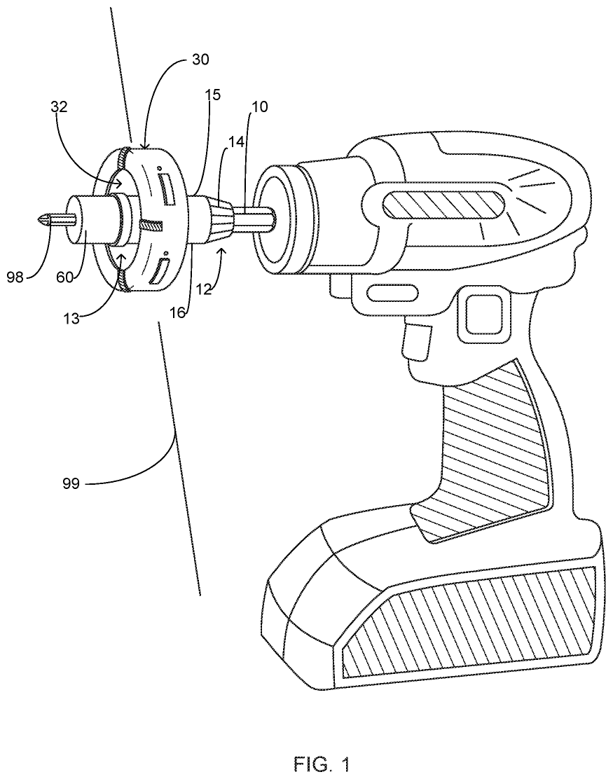

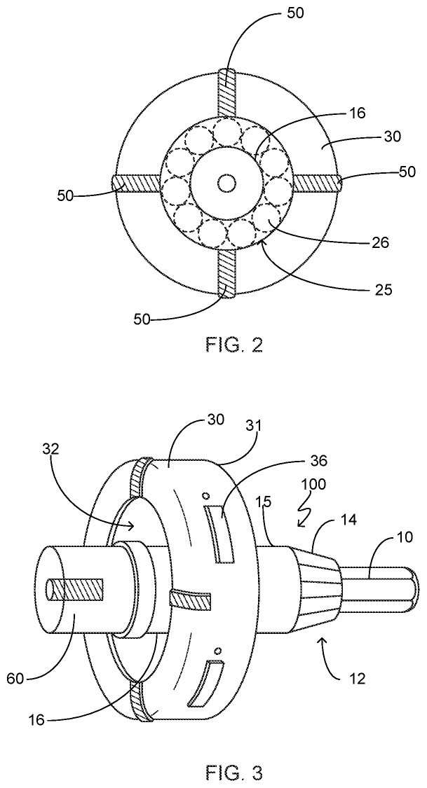

Referring in particular to FIG. 1, the drill accessory 100 includes a chuck engagement member 10. The chuck engagement member 10 is manufactured from a durable rigid material such as but not limited to metal. As is known in the art conventional drill chucks typically consist of three movable jaws that are configured to be surroundably secured to a drill bit or other device having a suitable diameter to be inserted into the drill chuck. The chuck engagement member 10 of the drill accessory 100 is illustrated herein as being hexagonal in shape but it is contemplated within the scope of the present invention that the chuck engagement member 10 could be manufactured in alternate shapes and diameter so as to be of suitable size to be insertable into a conventional drill chuck.

Secured to the chuck engagement member 10 is body 15. Body 15 is manufactured from a suitable durable material and is secured to chuck engagement member 10 proximate the first end 12 of the body 15. The first end 12 of the body 15 includes tapered portion adjacent to the chuck engagement member 10. The body 15 is secured to the chuck engagement member 10 utilizing suitable durable techniques such as but not limited to chemical adhesion. The body 15 is elongated and cylindrical in shape and includes outer wall 16. The body 15 is manufactured of a sufficient length to extend through the cavity 32 of the light assembly 30.

Adjacent to the outer wall 16 of the body 15 is bearing assembly 25. Bearing assembly 25 is secured to the body 15 utilizing suitable durable techniques and is operable to maintain the light assembly 30 in a stationary position during rotation of the body 15 as will be further discussed herein. The bearing assembly 25 includes a plurality of ball bearings 26 that are circumferentially present adjacent the body 15. The ball bearings 26 are disposed within the bearing assembly 25 so as to allow rotational movement of the ball bearings 26. The bearing assembly 25 functions to inhibit the transfer of the rotational movement of the body 15 to the light assembly 30 so as to maintain the light assembly 30 in a stationary position during rotational movement of the body 15. While a bearing assembly 25 has been illustrated and discussed herein for maintaining the light assembly 30 in a stationary position, it is contemplated within the scope of the present invention that alternate techniques and/or elements could be utilized in place of and/or in conjunction with the bearing assembly 25 to achieve the desired stationary position of the light assembly 30.

The light assembly 30 includes housing 31 manufactured from a suitable durable material such as but not limited to plastic. The housing 31 is annular in shape and includes cavity 32 configured to be adjacent the bearing assembly 25. The housing 31 has disposed therein a power supply (not illustrated herein) that is operable to provide power to the lights 50. It is contemplated within the scope of the present invention that the power supply could be either a replaceable power supply such as but not limited to a battery or a rechargeable power supply. The lights assembly 30 includes four lights 50. The lights 50 are positioned such that opposing lights are either along an x-axis or y-axis with respect to the center of the body 15. The lights 50 are configured to emit a straight line along the surface that is adjacent to the drill accessory 100 such as but not limited to a wall. The lights 50 in the preferred embodiment of the present invention are laser lights wherein the laser lights are configured to project a laser beam 99 onto the wall. The laser beam 99 projected onto the wall is projected in both an x-axis line and a y-axis line and provides a visual technique to align the exemplary bit 98 with another desired object such as but not limited to an adjacent fastener or a stud marker. Positioning of the lights 50 as illustrated herein allows the drill accessory 100 to provide a laser beam 99 both along a horizontal path and a vertical path so as to provide a user lateral and vertical options for alignment of the exemplary bit 98. While in the preferred embodiment the light assembly 30 includes four lights 50, it is contemplated within the scope of the present invention that the light assembly 30 could have as few as one light configured to emit a light beam onto an adjacent surface so as to provide alignment with a desired object. Additionally, while a laser light is preferred for the lights 50, it is contemplated within the scope of the present invention that the lights 50 could utilize other types of light emission. The light assembly 30 is controlled utilizing switch 36 which is a conventional power switch providing the ability to turn the lights 50 on or off.

The drill accessory 100 includes bit securing member 60 secured to the second end 13 of the body 15. The bit securing member 60 is contiguous with the body 15 and is secured thereto or formed as a part thereof utilizing suitable durable techniques. The bit securing member 60 is configured to have an exemplary bit 98 releasably secured therein. It is contemplated within the scope of the present invention that the bit securing member 60 could employ various elements to accomplish the desired task of securing exemplary bit therein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A drill accessory configured to emit at least one beam of light onto an adjacent surface comprising:
a chuck engagement member, said chuck engagement member configured to be inserted into a drill chuck;
a body, said body being secured to said chuck engagement member;
a light assembly, said light assembly being surroundably mounted to said body, said light assembly having at least one light proximate the perimeter thereof, said light assembly configured to maintain a stationary position during rotational movement of said body and wherein said at least one light is configured to project a light beam in a straight line outward from said light assembly and along an adjacent surface.

2. The drill accessory as recited in claim 1, wherein said body is cylindrical in shape, said body further having a first end and a second end, said second end of said body configured to extend beyond said light assembly.

3. The drill accessory as recited in claim 2, wherein said light assembly includes a cavity, said cavity of said light assembly configured to have a portion of said body extend therethrough.

4. The drill accessory as recited in claim 3, and further including a bearing assembly, said bearing assembly being intermediate said body and said light assembly, said bearing assembly configured to inhibit movement of the light assembly during rotational movement of said body.

5. The drill accessory as recited in claim 4, and further including a bit securing member, said bit securing member being present on said second end of said body, said bit securing member configured to releasably retain an exemplary drill bit.

6. The drill accessory as recited in claim 5, wherein the bearing assembly further includes a plurality of ball bearings disposed therein.

7. The drill accessory as recited in claim 6, wherein the at least one light of said light assembly is a laser light.

8. A drill accessory configured to be releasably secured to a drill chuck wherein the drill accessory is configured to project a straight line outward therefrom and along an adjacent surface wherein the drill accessory comprises:
a chuck engagement member, said chuck engagement member configured to be inserted into a drill chuck;
a body, said body being secured to said chuck engagement member, said body having a first end and a second end, said body being cylindrical in shape;
a light assembly, said light assembly being surroundably mounted to said body, said light assembly being annular in shape having an outer perimeter, said light assembly having at least two lights located on the outer perimeter thereof, a bearing assembly, said bearing assembly being intermediate said body and said light assembly; and
wherein said bearing assembly is configured to maintain said light assembly in a stationary position during rotational movement of said body.

9. The drill accessory as recited in claim 8, wherein said at least two lights are diametrically opposed on the outer perimeter of the light assembly.

10. The drill accessory as recited in claim 9, wherein said bearing assembly further includes a plurality of ball bearings, said ball bearings being circumferentially adjacent said body, said ball bearings inhibiting rotational movement of the light assembly during rotational movement of the body.

11. The drill accessory as recited in claim 10, wherein said at least two lights are configured to project a straight line light beam onto an adjacent surface in either an x-axis direction, a y-axis direction or a combination thereof.

12. The drill accessory as recited in claim 11, and further including a bit securing member, said bit securing member configured to releasably retain a drill bit, said bit securing member being contiguous with the second end of said body.

13. The drill accessory as recited in claim 12, wherein said light assembly further includes a cavity, said cavity configured to have a portion of the body journaled therethrough.

14. The drill accessory as recited in claim 13, wherein the at least two lights are laser lights.

15. A drill accessory configured to be releasably secured into a handheld drill wherein the drill accessory is operable to project a straight line light beam along an x-axis and a y-axis onto an adjacent surface wherein the drill accessory comprises:
a chuck engagement member, said chuck engagement member configured to be inserted into a drill chuck;
a body, said body being secured to said chuck engagement member, said body having a first end and a second end, said body being cylindrical in shape;
a light assembly, said light assembly being surroundably mounted to said body, said light assembly being annular in shape having an outer perimeter, said light assembly having four lights located equidistantly with respect to each other along the outer perimeter of the light assembly,
a bearing assembly, said bearing assembly being intermediate said body and said light assembly, said bearing assembly having a plurality of ball bearings disposed therein, said plurality of ball bearings operable to inhibit transfer of rotational movement of the body to the light assembly so as to maintain the light assembly in a stationary position during rotational movement of the body.

16. The drill accessory as recited in claim 15, wherein said light assembly further includes a cavity, said cavity configured to have a portion of the body journaled therethrough.

17. The drill accessory as recited in claim 16, and further including a bit securing member, said bit securing member configured to releasably retain a drill bit, said bit securing member being contiguous with the second end of said body.

18. The drill accessory as recited in claim 17, wherein said four lights are configured to project a straight line light beam onto an adjacent surface in an x-axis direction and a y-axis direction.

19. The drill accessory as recited in claim 18, wherein said light assembly further includes a switch, said switch configured to transition the lights between an on position and an off position.

20. The drill accessory as recited in claim 19, wherein said four lights are laser lights.
